(19) United States
(12) Patent Application Publication
(10) Pub. No.: US 2014/0156538 A1
(43) Pub. Date: Jun. 5, 2014

(54) Customer Contact Management

(71) Applicant: AT&T INTELLECTUAL PROPERTY I, L.P., Atlanta, GA (US)

(72) Inventors: Veeramani Kandasamy, Annandale, NJ (US); James Gordon Beattie, JR., Bergenfield, NJ (US)

(73) Assignee: AT&T INTELLECTUAL PROPERTY I, L.P., Atlanta, GA (US)

(21) Appl. No.: 13/705,510

(22) Filed: Dec. 5, 2012

(51) Int. Cl. G06Q 30/00

(52) U.S. Cl. CPC G06Q 30/016
USPC 705/304

(57) ABSTRACT

Concepts and technologies are disclosed herein for customer contact management. According to one aspect described herein, a method can include a computing system receiving customer information from a customer access point. The method can also include the computing system generating a customer contact plan based at least in part upon the customer information. The customer contact plan can be useable by an individual to provide a service to a customer associated with the customer information. The method can also include the computing system presenting the customer contact plan to the individual so that the individual can utilize the customer contact plan to provide the service to the customer.

### BACKGROUND

The concepts and technologies disclosed herein generally relate to customer service. More specifically, the concepts and technologies disclosed herein relate to customer contact management.

Customer loyalty metrics, such as NET PROMOTOR SCORE (“NPS”) from Satmetrix Systems, Inc., Bain & Company, Inc., and Fred Reichheld, are often used to assess the loyalty of a company's customer base. NPS considers three types of people: detractors, passives, and promoters. Detractors are unhappy customers who can damage a company's brand(s) and impede growth of the company through negative word-of-mouth. In recent years, with the proliferation of social networks, such as FACEBOOK and TWITTER, detractors can voice their opinions to a much larger audience, which may be on the order of millions of people. Passives are customers who are satisfied but unenthusiastic about a company's brand(s). Passives are potentially more vulnerable to competitive offerings. Promoters are loyal brand enthusiasts who keep buying products and/or services from a company and refer others to do so as well, fueling company growth. NPS results are calculated by taking the percentage of promoters and subtracting the percentage of detractors. Companies may use NPS results and/or other customer loyalty metrics to plan changes in business practices towards the goal of improving customer relations.

### SUMMARY

According to one aspect of the concepts and technologies disclosed herein, a method is disclosed. The method can include a computing system receiving customer information from a customer access point. The method can also include the computing system generating a customer contact plan based at least in part upon the customer information. The customer contact plan can be useable by an individual to provide a service to a customer associated with the customer information. The method can also include the computing system presenting the customer contact plan to the individual so that the individual can utilize the customer contact plan to provide the service to the customer.

In some embodiments, the method can also include the computing system receiving additional customer information. The additional customer information can include, but is not limited to, sales information, service information, billing information, installation information, device repair information, customer service chat record information, customer service call record information, customer service email record information, appointment information for an appointment associated with the customer, social network information associated with the customer, or any combination thereof. In some embodiments, the additional customer information is received in a customer profile associated with the customer.

In some embodiments, the method can also include the computing system receiving location information associated with the customer. In these embodiments, the computing system can generate the customer contact plan in response to receiving the location information associated with the customer and determining that the location information indicates that the customer is within a predetermined distance of a store associated with the customer access point.

In some embodiments, the computing system receives the customer information from the customer access point in response to the customer access point detecting a customer device associated with the customer and receiving the customer information from the customer device.

In some embodiments, the method can also include the computing system receiving service completion information that identifies a result of the service provided to the customer in accordance with the customer contact plan. The method can also include updating the customer profile associated with the customer based upon the service completion information.

In some embodiments, the customer contact plan includes a predicted reason for the customer requiring the service.

According to another aspect of the concepts and technologies disclosed herein, a computing system is disclosed. The computing system can include a processor and a memory storing instructions that, when executed by the processor, cause the processor to perform operations. The operations can include receiving customer information from a customer access point. The operations can also include generating a customer contact plan based at least in part upon the customer information. The customer contact plan can be useable by an individual to provide a service to a customer associated with the customer information. The operations can also include presenting the customer contact plan to the individual so that the individual can utilize the customer contact plan to provide the service to the customer.

According to another aspect of the concepts and technologies disclosed herein, a computer storage medium is disclosed. The computer storage medium can have instructions stored thereon that, when executed by a processor, cause the processor to perform operations. The operations can include receiving customer information from a customer access point. The operations can also include generating a customer contact plan based at least in part upon the customer information. The customer contact plan can be useable by an individual to provide a service to a customer associated with the customer information. The operations can also include presenting the customer contact plan to the individual so that the individual can utilize the customer contact plan to provide the service to the customer.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating aspects of an illustrative operating environment for various concepts disclosed herein.

FIG. 2 is a flow diagram illustrating aspects of a method for providing a customer contact plan to a service individual for use by the service individual in providing a service to a customer, according to an illustrative embodiment.

FIG. 3 is a flow diagram illustrating aspects of a method for collecting customer information from a customer device, according to an illustrative embodiment.

FIG. 4 is a flow diagram illustrating aspects of a method for generating and managing a customer profile, according to an illustrative embodiment.

FIG. 5 schematically illustrates a network, according to an illustrative embodiment.

FIG. 6 is a block diagram illustrating an example computer system capable of implementing aspects of the embodiments presented herein.

FIG. 7 is a block diagram illustrating an example mobile device capable of implementing aspects of the embodiments disclosed herein.

### DETAILED DESCRIPTION

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer system, including hand-held devices, mobile devices, wireless devices, multiprocessor systems, distributed computing systems, microprocessor-based or programmable consumer electronics, minicomputers, mainframe computers, routers, switches, other computing devices described herein, and the like.

In the following detailed description, references are made to the accompanying drawings that form a part hereof, and in which are shown by way of illustration specific embodiments or examples. Referring now to the drawings, in which like numerals represent like elements throughout the several figures, example aspects of non-native device authentication will be presented.

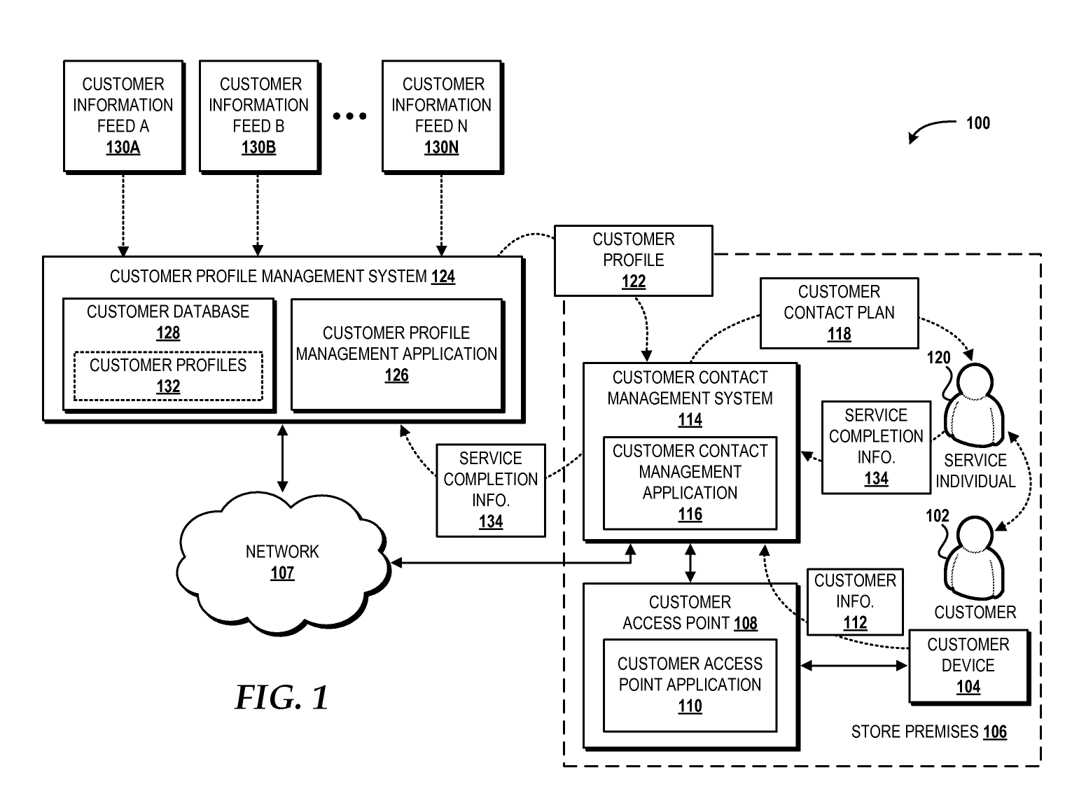

Referring now to FIG. 1, aspects of an operating environment 100 for various embodiments of the concepts and technologies disclosed herein for customer contact management will be described, according to an illustrative embodiment. It should be understood that the operating environment 100 and the various components thereof have been greatly simplified for purposes of discussion. The operating environment 100 shown in FIG. 1 includes a customer 102 who is associated with a customer device 104. The customer 102 has entered or is within a predetermined vicinity of a store premises 106. More particularly, the customer device 104 is within a coverage area of a customer access point 108. The customer 102 has entered or is going to enter the store premises 106 to take part in one or more services offered by a company or other entity that is associated with the store premises 106. In some embodiments, the service includes a retail service, a mobile communications service, a device repair service, or the like. It should be understood, however, that the concepts and technologies disclosed herein may be applied to providing any service.

The customer device 104 can operate in communication with and/or as part of one or more communications networks (“network”) 107. According to various embodiments, the functionality of the customer device 104 may be provided by one or more server computers, desktop computers, mobile communications devices (e.g., cellular telephones, feature phones, or smartphones), laptop computers, set-top boxes, other computing systems, other computing devices, and the like. It should be understood that the functionality of the customer device 104 can be provided by a single device, by two similar devices, and/or by two or more dissimilar devices. For purposes of describing the concepts and technologies disclosed herein, the customer device 104 is described herein as a mobile communications device, and the service provided within the store premises 106 includes a customer support service for the customer 102, who is a customer of one or more mobile communications services that are provided at least in part by a mobile communications carrier that is associated with the store premises 106. It should be understood that this embodiment is illustrative, and should not be construed as being limiting in any way.

The customer device 104 can execute an operating system (not shown) and one or more application programs (also not shown). The operating system is a computer program for controlling the operation of the customer device 104. The application programs are executable programs configured to execute on top of the operating system to provide various functions.

The customer device 104 can communicate with the customer access point 108 via one or more wireless or wired communication technologies. For example, the customer device 104 can communicate with the customer access point 108 via BLUETOOTH, infrared, infrared data association (“IRDA”), near field communications (“NFC”), one or more Institute of Electrical and Electronic Engineers (“IEEE”) 802.11 standards such as IEEE 802.11a, 802.11b, 802.11g, 802.11n, and/or future 802.11 standard (referred to herein collectively as “WI-FI”), other RF technologies, universal serial bus (“USB”), and/or the like.

The customer access point 108 can execute an operating system (not shown) and one or more application programs, such as, for example, a customer access point application 110. The customer access point application 110 can execute on top of the operating system to provide functionality such as detecting the presence of the customer device 104 within a coverage area provided by the customer access point 108 using one or more of the aforementioned technologies and obtaining customer information 112 from the customer device 104. In some embodiments, the customer access point 108 can detect the presence of the customer device 104 within a coverage area that includes the store premises 106 and an area outside of the store premises 106. In this implementation, the customer access point 108 can detect the presence of the customer device 104 before the customer device 104 crosses a threshold into the store premises 106. In some other embodiments, the customer access point 108 can detect the presence of the customer device 104 within an area defined by the store premises 106 or some portion of the store premises 106.

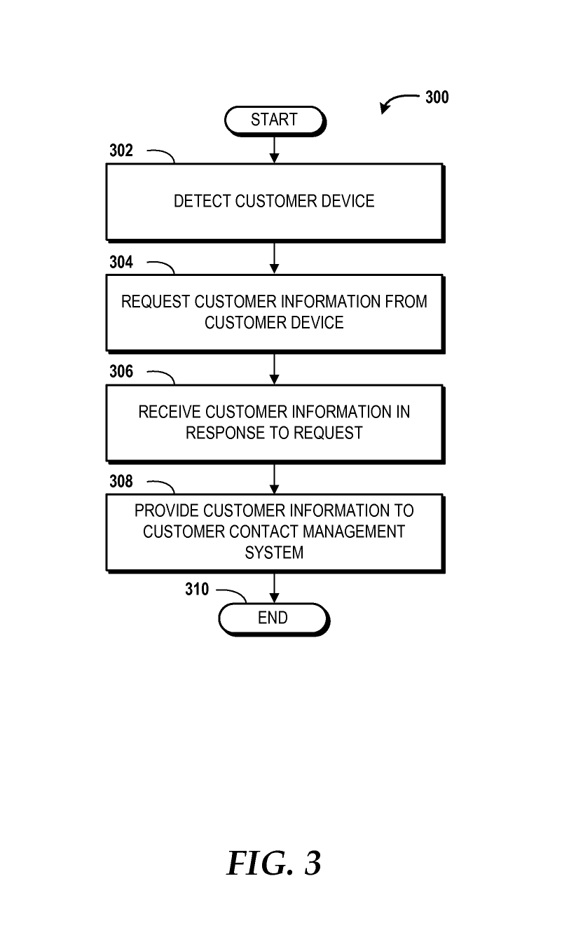

The customer access point 108 can request the customer information 112 from the customer device 104 and, in response to the request, receive the customer information 112 from the customer device 104. Alternatively, the customer access point 108 can wait for the customer device 104 to provide the customer information 112 unprompted, such as when the customer device 104 detects the customer access point 108. In any case, the customer access point 108 can receive the customer information 112 from the customer device 104 and provide the customer information 112 to a customer contact management system 114. Additional details regarding some aspects of the customer access point 108 are described herein below with reference to FIG. 3.

The customer information 112 can include any information associated with the customer 102. In some instances, the customer information 112 includes basic information, such as a name, honorific, and/or title, which can be used to greet the customer 102. The customer information 112 can include additional information such as a reason why the customer 102 is visiting the store premises 106.

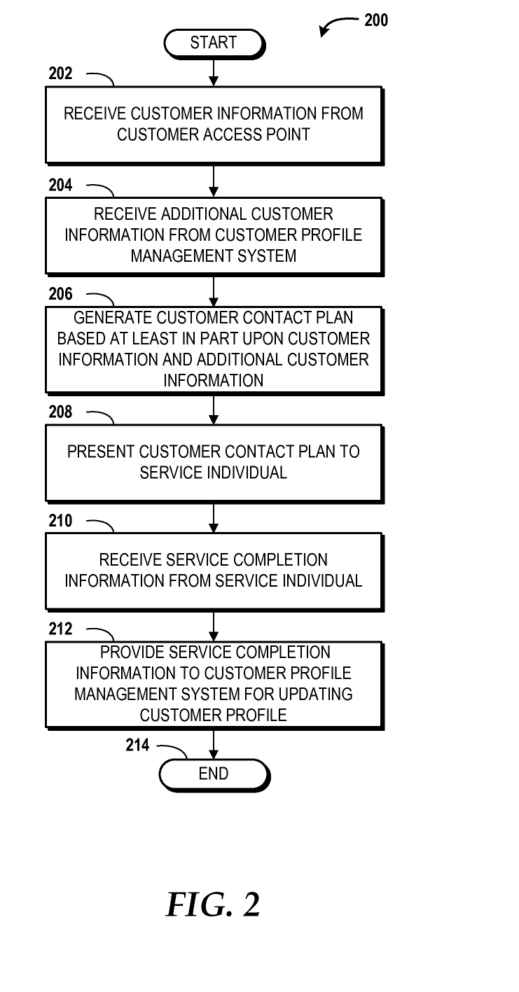

The customer contact management system 114 can execute an operating system (not shown) and one or more application programs, such as, for example, a customer contact management application 116. The operating system is a computer program for controlling the operation of the customer contact management system 114. The customer contact management application 116 is an executable program configured to execute on top of the operating system to provide various functions, such as, for example, receiving the customer information 112 from the customer access point 108 and generating a customer contact plan 118 based at least in part upon the customer information 112. The customer contact management application 116 can provide the customer contact plan 118 to a service individual 120 who is intending to contact or is in the process of contacting the customer 102 to provide a service to the customer 102. Additional details regarding some aspects of the customer contact management system 114 are described herein below with reference to FIG. 2.

In some embodiments, location information associated with the customer device 104 can be received by the customer contact management system 114 via, for example, a location determining component of the network 107. In these embodiments, the customer contact management system 114 can generate the customer contact plan 118 in response to receiving the location information associated with the customer 102 and determining that the location information indicates that the customer 102 is within a predetermined distance of the store premises 106.

The customer contact plan 118 can provide a plan in regards to how the service individual 120 should handle contact with the customer 102. For example, the customer contact plan 118 can identify a salutation using the customer's name obtained from the customer information 112 and a plan of action for providing a service to the customer 102. The customer contact plan 118 can convey information regarding how to assist the customer 102 via any visual and/or audio means, including pictures, diagrams, text, audible instructions, available promotions, and the like.

In some embodiments, the customer contact management system 114 presents the customer contact plan 118 to the service individual 120 via one or more displays, which may be in wired or wireless communication with the customer contact management system 114. In some embodiments, the customer contact management system 114 presents the customer contact plan 118 via a display of a tablet computing device or other portable computing device that is in wireless communication with the customer contact management system 114. In some other embodiments, the customer contact management system 114 is or includes a kiosk that is useable by the service individual to retrieve the customer contact plan 118.

In some embodiments, the customer contact management system 114 presents the customer contact plan 118 to the service individual 120 via a printer, which may be in wired or wireless communication with the customer contact management system 114. In some embodiments, the customer contact management system 114 presents the customer contact plan 118 to the service individual 120 via one or more speakers, which may be in wired or wireless communication with the customer contact management system 114. In some embodiments, the customer contact management system 114 presents the customer contact plan 118 via a speaker or earpiece (e.g., headphone) of a tablet computing device or other portable computing device that is in wireless communication with the customer contact management system 114.

The customer contact management system 114 can also receive a customer profile 122 associated with the customer 102 from a customer profile management system 124 via the network 107. The customer profile 122 can include additional customer information associated with the customer 102. The additional customer information can include sales information, service information, billing information, installation information, device repair information, customer service chat record information, customer service call record information, customer service email record information, appointment information for an appointment associated with the customer 102, social network information associated with the customer, or any combination thereof. In some embodiments, the customer profile management system 124 is owned and/or operated by the same entity that owns and/or operates the store premises 106 and/or provides the service within the store premises 106. In some other embodiments, the customer profile management system 124 is another company or entity.

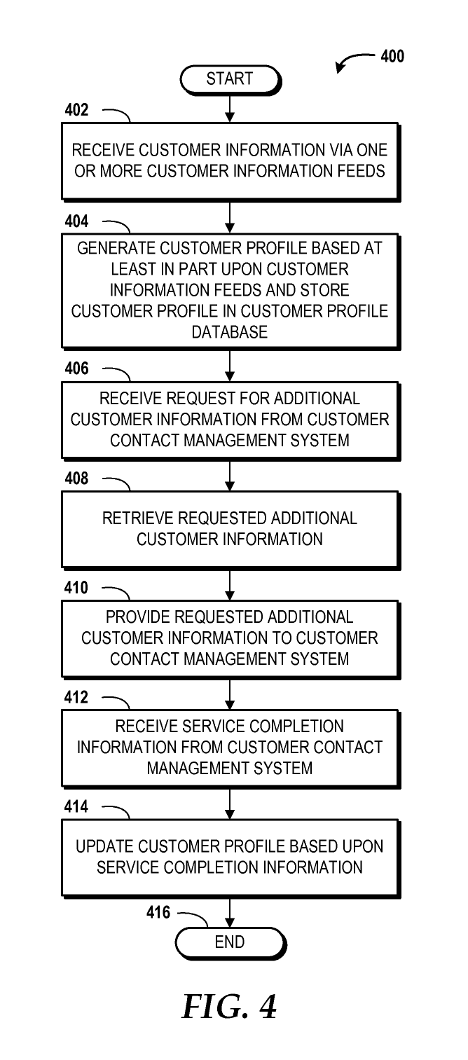

The customer profile management system 124 can execute an operating system (not shown) and one or more application programs, such as, for example, a customer profile management application 126 and a customer database 128. The operating system is a computer program for controlling the operation of the customer profile management application 126 and the customer database 128. The customer profile management application 126 is an executable program configured to execute on top of the operating system to provide various functions, such as, for example, receiving customer information associated with the customer 102 via one or more customer information feeds 130A-130N, generating the customer profile 122 and/or other customer profiles 132 that can be stored in the customer database 128. Additional details regarding some aspects of the customer profile management system 124 are described herein below with reference to FIG. 4.

The customer information feeds 130A-130N can be provided by any number of servers, computers, networking devices, databases, websites, social networks, billing systems, charging systems, email servers, Internet archives, and the like. The customer information feeds 130A-130N can provide sales information, service information, billing information, installation information, device repair information, customer service chat record information, customer service call record information, customer service email record information, appointment information for an appointment associated with the customer, social network information associated with the customer, or any combination thereof to the customer profile management system 124. In some embodiments, one or more of the customer information feeds 130A-130N are from one or more servers, computers, or other systems associated with providing a service to the customer 102. In some embodiments, one or more of the customer information feeds 130A-130N are from one or more servers, computers, or other systems that are capable of providing information associated with the customer 102 that is not directly related to the customer 102. Such information can include, for example, friends and/or family members of the customer 102 in the real-world, in one or more virtual worlds (e.g., video games), and/or in one or more social networks.

The customer profile management application 126 can also receive service completion information 134 from the customer contact management system 114 and update the customer profile 122 based upon the service completion information 134. The service completion information 134 can include information input directly by or for the service individual 120 in regards to a result of the contact between the service individual 120 and the customer 102. The service completion information 134 can additionally or alternatively include information associated with a purchase transaction or other transaction between the customer 102 and the company or entity associated with the store premises 106.

FIG. 1 illustrates one customer 102, one customer device 104, one store premises 106, one network 107, one customer access point 108, one customer access point application 110, one customer contact management system 114, one customer contact management application 116, one customer contact plan 118, one service individual 120, one customer profile 122, one customer profile management system 124, one customer profile management application 126, and one customer database 128. It should be understood, however, that various implementations of the operating environment 100 include multiple customers 102, customer devices 104, store premises 106, networks 107, customer access points 108, customer access point applications 110, customer contact management systems 114, customer contact management applications 116, customer contact plans 118, service individuals 120, customer profiles 122, customer profile management systems 124, customer profile management applications 126, and customer databases 128. As such, the illustrated embodiment should be understood as being illustrative, and should not be construed as being limiting in any way.

Although the operating environment 100 is described in context of a physical store premises, the operating environment 100 can additional include a virtual store premises. In this alternative embodiment, the customer access point 108 can be replaced with other points of access to the customer 102 such as a customer phone call, the customer's web presence, a customer log-in to a website, a customer chat session, or any other point of contact with the customer 102. The other details regarding aspect of customer contact management described herein are also applicable to these embodiments.

Turning now to FIG. 2, aspects of a method 200 for providing a customer contact plan to a service individual for use by the service individual in providing a service to a customer will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as, the customer device 104, the customer access point 108, the customer contact management system 114, and/or the customer profile management system 124 to perform one or more operations and/or causing the processor to direct other components of the computing system or device to perform one or more of the operations.

For purposes of illustrating and describing the concepts of the present disclosure, the methods disclosed herein are described as being performed by the customer contact management system 114 via execution of one or more software modules such as, for example, the customer contact management application 116. It should be understood that additional and/or alternative devices and/or network nodes can provide the functionality described herein via execution of one or more modules, applications, and/or other software including, but not limited to, the customer contact management application 116. Thus, the illustrated embodiments are illustrative, and should not be viewed as being limiting in any way.

The method 200 begins at operation 202, wherein the customer contact management system 114 receives the customer information 112 from the customer access point 108. From operation 202, the method 200 proceeds to operation 204, wherein the customer contact management system 114 receives additional customer information from the customer profile management system 124. The additional information can include, for example, additional customer information within the customer profile 122. It should be understood that the additional customer information may be received in a raw format. In other words, the additional customer information may be received by the customer contact management system 114 from the customer profile management system 124 without being formatted as information within a customer profile. For example, a portion or all of the customer feed information 130A-130N associated with the customer 102 may be received by the customer contact management system 114 from the customer profile management system 124 without the customer profile management system 124 having formatted the customer feed information 130A-130N within a customer profile.

From operation 204, the method 200 proceeds to operation 206, wherein the customer contact management system 114 generates the customer contact plan 118 based at least in part upon the customer information 112 and the additional customer information 114. The customer contact management system 114 may alternatively generate the customer contact plan 118 based upon the customer information 112 or the additional customer information 114. From operation 206, the method 200 proceeds to operation 208, wherein the customer contact management system 114 presents the customer contact plan 118 to the service individual 120. The service individual 120 can utilize the customer contact plan 118 to provide a service to the customer 102. The service is customized for the customer 102 based upon the customer information 112 and/or the additional customer information received at operation 202 and at operation 204, respectively.

In some embodiments, the customer contact management system 114 presents the customer contact plan 118 to the service individual 120 in a visual format, which may include diagrams, pictures, videos, text, or other visual representations of content included in the customer contact plan 118, via one or more displays that are in wired or wireless communication with the customer contact management system 114. In some other embodiments, which may be combined with the aforementioned embodiments, the customer contact management system 114 presents the customer contact plan 118 to the service individual 120 in an audio format, which may include audible instructions or other audible representations of content included in the customer contact plan 118, via one or more speakers that are in wired or wireless communication with the customer contact management system 114. In some embodiments, the display(s) and/or the speaker(s) are provided on a mobile device associated with the service individual 120.

From operation 208, the method 200 proceeds to operation 210, wherein the customer contact management system 114 receives the service completion information 134 from the service individual 120. From operation 210, the method 200 proceeds to operation 212, wherein the customer contact management system 114 provides the service completion information 134 to the customer profile management system 124 for use by the customer profile management system 124 to update the customer profile 122 associated with the customer 102.

From operation 212 the method 200 proceeds to operation 214. The method 200 ends at operation 214.

Turning now to FIG. 3, aspects of a method 300 for collecting customer information from a customer device will be described in detail, according to an illustrative embodiment. The method 300 begins at operation 302, wherein the customer access point 108 detects the presence of the customer device 104. From operation 302, the method 300 proceeds to operation 304, wherein the customer access point 108 requests the customer information 112 from the customer device 104. Alternatively, the customer device 104 may provide the customer information 112 to the customer access point 108 upon detecting the customer access point 108. From operation 304, the method 300 proceeds to operation 306, wherein the customer access point 108 receives the customer information 112 from the customer device 104 in response to the request received at operation 304, or alternatively from the customer device 104 without request.

From operation 306, the method 300 proceeds to operation 308, wherein the customer access point 108 provides the customer information 112 to the customer contact management system 114 for use by the customer contact management system 114 in generating the customer contact plan 118.

From operation 308, the method 300 proceeds to operation 310. The method 300 ends at operation 310.

Although not shown in FIG. 3, it should be understood that the customer access point 108 can take various actions in addition to, or instead of, requesting the customer information 112 as described above with reference to operation 304. For example, the customer access point 108 can send promotional materials such as coupons, advertisements, and/or other content, and/or take other actions. In some embodiments, the content sent by the customer access point 108 to the customer device 102 includes content associated with an entity other than the entity or entities associated with providing the service in accordance with the customer contact plan 118. For example, the customer access point 108 may provide content associated with a company that owns and/or operates one or more stores within a predetermine vicinity of the store premises 106 with which the customer access point 108 is associated. As such, the illustrated embodiment of FIG. 3 is illustrative and should not be construed as being limiting in any way.

Turning now to FIG. 4, aspects of a method 400 for generating and managing a customer profile will be described in detail, according to an illustrative embodiment. The method 400 begins at operation 402, wherein the customer management profile system 124 receives customer information associated with the customer 102 via one or more of the customer information feeds 134. From operation 402, the method 400 proceeds to operation 404, wherein the customer management profile system 124 generates the customer profile 122 for the customer 102. The customer management profile system 124 also stores the customer profile 122 in the customer database 128 at operation 404.

From operation 404, the method 400 proceeds to operation 406, wherein the customer management profile system 124 receives a request for additional customer information from the customer contact management system 114. From operation 406, the method 400 proceeds to operation 408, wherein the customer management profile system 124 retrieves the requested additional customer information from the customer database 128. The additional customer information can include the customer profile 122 or raw information received via one or more of the customer information feeds 134 in associated with the customer 102. From operation 408, the method 400 proceeds to operation 410, wherein the customer management profile system 124 provides the requested additional information to the customer contact management system 114.

From operation 410, the method 400 proceeds to operation 412, wherein the customer management profile system 124 receives the service completion information 134. From operation 412, the method 400 proceeds to operation 414, wherein the customer management profile system 124 updates the customer profile 122 based upon the service completion information 134.

From operation 414, the method 400 proceeds to operation 416. The method 400 ends at operation 416.

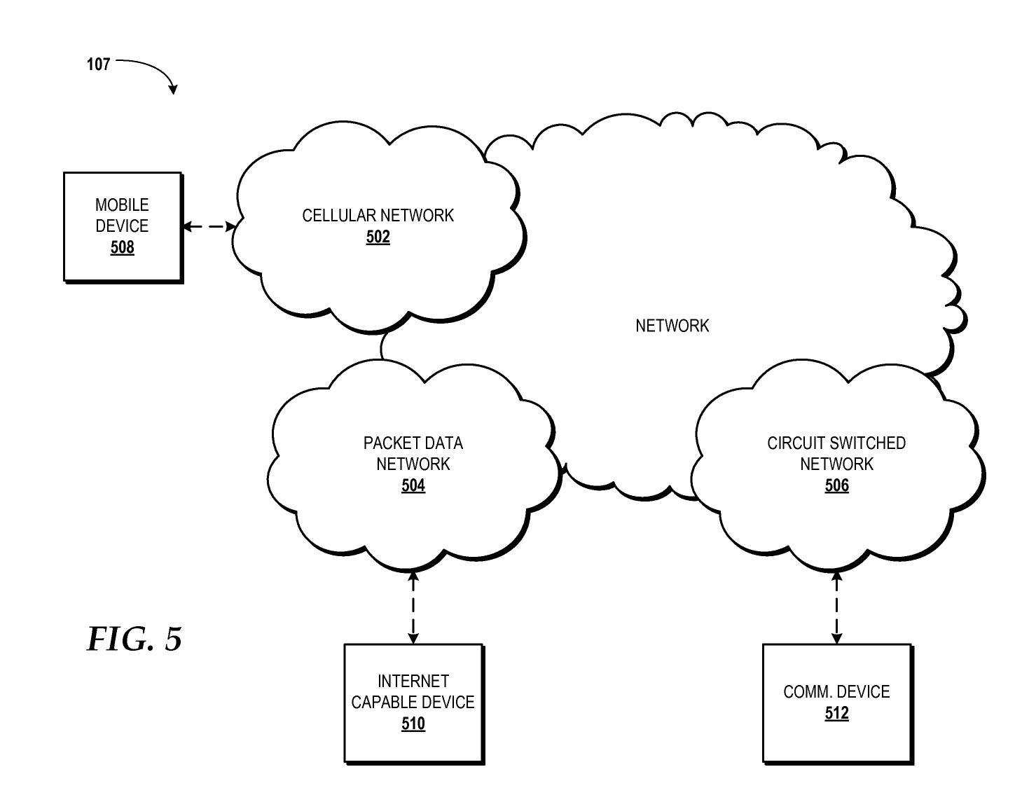

Turning now to FIG. 5, additional details of the network 107 are illustrated, according to an illustrative embodiment. The network 107 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured to operate in accordance with one or more mobile communications standards including, but not limited to, Global System for Mobile communications (“GSM”), Code Division Multiple Access (“CDMA”) ONE, CDMA2000, Universal Mobile Telecommunications System (“UMTS”), Long-Term Evolution (“LTE”), Worldwide Interoperability for Microwave Access (“WiMAX”), other 802.XX technologies, and/or the like. Moreover, the cellular network 502 can be configured to utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and/or the like to provide a radio/air interface to the mobile communications device 508. The cellular network can be configured to provide data communications using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and/or various other current and future wireless data access technologies.

The packet data network 504 includes various devices, for example, servers, computers, databases, and other devices in communication with another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (“POTS”). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 107 is used to refer broadly to any combination of the networks 502, 504, 506. It should be appreciated that substantially all of the functionality described with reference to the network 107 can be performed by the cellular network 502, the packet data network 504, and/or the circuit switched network 506, alone or in combination with other networks, network elements, and the like.

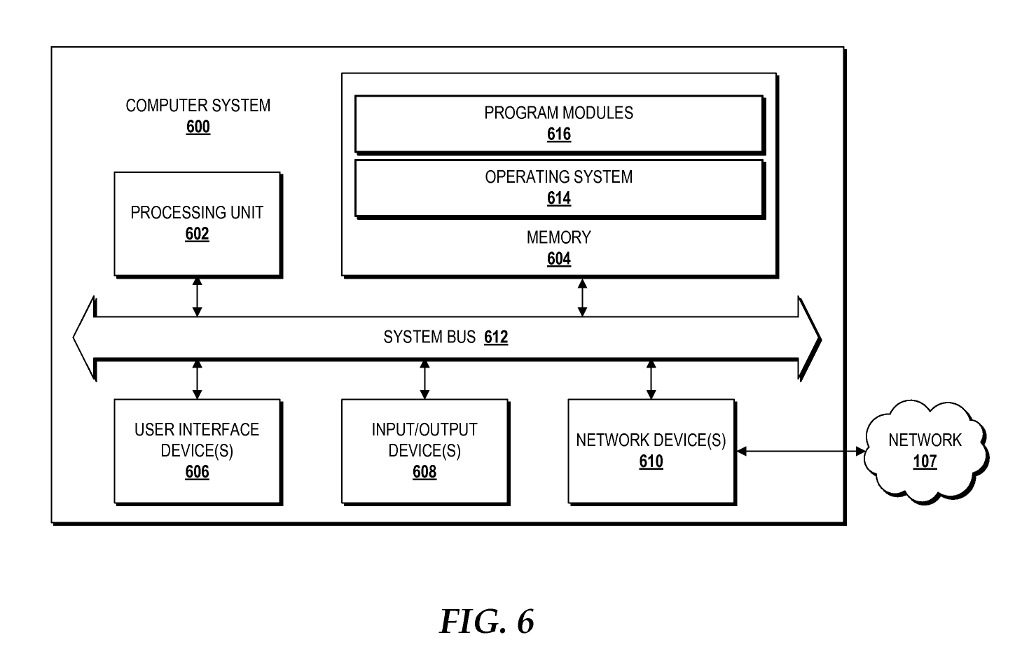

FIG. 6 is a block diagram illustrating a computer system 600 configured to provide the functionality described herein for customer contact management, in accordance with various embodiments of the concepts and technologies disclosed herein. The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. Processing units are generally known, and therefore are not described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 include the customer access point application 110, the customer contact management application 116, and/or the customer profile management application 126. This and/or other programs can be embodied in computer-readable media containing instructions that, when executed by the processing unit 602, perform one or more of the methods 200, 300, 400 described in detail above with respect to FIGS. 2-4. According to embodiments, the program modules 616 may be embodied in hardware, software, firmware, or any combination thereof. Although not shown in FIG. 6, it should be understood that the memory 604 also can be configured to store the customer information 112, the customer contact plan 118, the service completion information 134, the customer profile 122, the customer profiles 132, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 107. Examples of the network devices 610 include, but are not limited to, a modem, a radio frequency (“RF”) or infrared (“IR”) transceiver, a telephonic interface, a bridge, a router, or a network card. The network 107 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 107 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

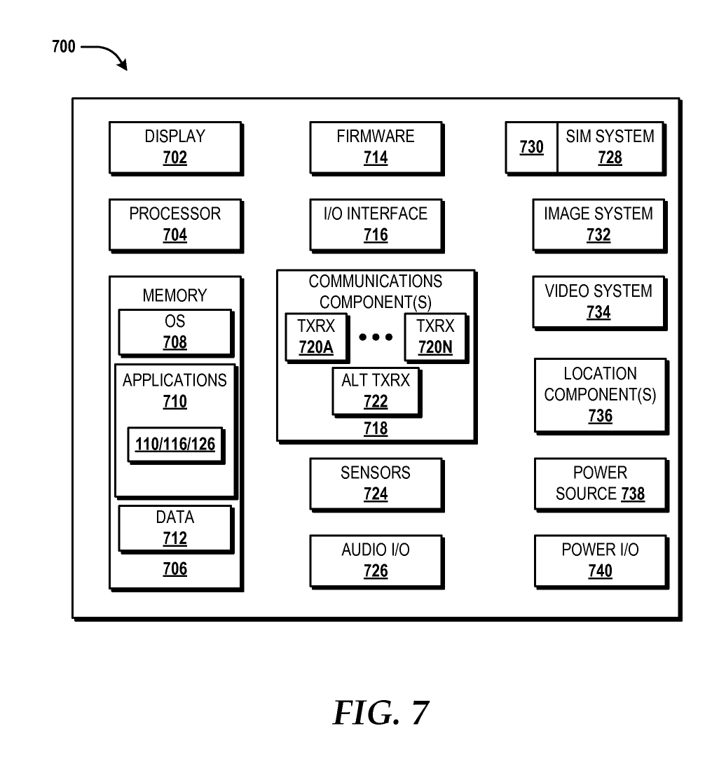

Turning now to FIG. 7, an illustrative mobile device 700 and components thereof will be described. In some embodiments, the customer device 104, the customer access point 108, the customer contact management system 114, and/or the customer profile management system 124 described above with reference to FIG. 1 can be configured as and/or can have an architecture similar or identical to the mobile device 700 described herein in FIG. 7. It should be understood, however, that the customer device 104, the customer access point 108, the customer contact management system 114, and/or the customer profile management system 124 may or may not include the functionality described herein with reference to FIG. 7. While connections are not shown between the various components illustrated in FIG. 7, it should be understood that some, none, or all of the components illustrated in FIG. 7 can be configured to interact with one other to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various graphical user interface (“GUI”) elements, text, images, video, virtual keypads and/or keyboards, messaging data, notification messages, metadata, internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710 such as the customer access point application 110, the customer contact management application 116, the customer profile management application 126, other computer-executable instructions stored in a memory 708, or the like. In some embodiments, the applications 706 also can include a UI application (not illustrated in FIG. 7).

The UI application can interface with the operating system 708 to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, viewing account information, answering/initiating calls, entering/deleting data, entering and setting user IDs and passwords for device access, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700. The data 712 can include, for example, the customer information 112, the customer contact plan 118, the service completion information 134, the customer profile 122, the customer profiles 132, customer information retrieved via one or more of the customer information feeds 130A-130N, and/or other applications or program modules. According to various embodiments, the data 712 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interfaced 716 can be configured to support the input/output of data such as location information, user information, organization information, presence status information, user IDs, passwords, and application initiation (start-up) requests. In some embodiments, the I/O interface 716 can include a hardwire connection such as USB port, a mini-USB port, a micro-USB port, an audio jack, a PS2 port, an IEEE 1394 (“FIREWIRE”) port, a serial port, a parallel port, an Ethernet (RJ411) port, an RJ11 port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks such as the network 107 described herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMAONE, CDMA2000, LTE, and various other 2G, 2.5G, 3G, 4G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family including HSDPA, EUL or otherwise termed HSUPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, IRDA), NFC, other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

Based on the foregoing, it should be appreciated that systems and methods for customer contact management have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
receiving, by a computing system comprising a processor, customer information from a customer access point that requests the customer information from a customer device associated with a customer and receives the customer information from the customer device associated with the customer;
generating, by the computing system, a customer contact plan based at least in part upon the customer information, the customer contact plan being useable by an individual to provide a service to a customer associated with the customer information; and
presenting, by the computing system, the customer contact plan to the individual so that the individual can utilize the customer contact plan to provide the service to the customer.

2. The method of claim 1, further comprising receiving, by the computing system, additional customer information comprising sales information, service information, billing information, installation information, device repair information, customer service chat record information, customer service call record information, customer service email record information, appointment information for an appointment associated with the customer, social network information associated with the customer, or any combination thereof.

3. The method of claim 2, wherein receiving, by the computing system, the additional customer information from the customer database comprises receiving, by the computing system, a customer profile associated with the customer, the customer profile comprising the additional customer information.

4. The method of claim 1, further comprising receiving, by the computing system, location information associated with the customer, and wherein generating, by the computing system, the customer contact plan comprises generating, by the computing system, the customer contact plan in response to receiving the location information associated with the customer and determining that the location information indicates that the customer is within a predetermined distance of a store associated with the customer access point.

5. The method of claim 1, further comprising detecting, by the customer access point, the customer device, and wherein the customer information is received from the customer device in response to the customer access point detecting the customer device and requesting the customer information from the customer device.

6. The method of claim 1, further comprising receiving service completion information that identifies a result of the service provided to the customer in accordance with the customer contact plan.

7. The method of claim 6, further comprising updating, by the computing system, a customer profile associated with the customer with the service completion information.

8. The method of claim 1, wherein the customer contact plan comprises a predicted reason for the customer requiring the service.

9. A system comprising:
a processor; and
a memory storing computer-executable instructions that, when executed by the processor, cause the processor to perform operations comprising
receiving customer information from a customer access point that requests the customer information from a customer device associated with a customer and receives the customer information from the customer device associated with the customer,
generating a customer contact plan based at least in part upon the customer information, the customer contact plan being useable by an individual to provide a service to a customer associated with the customer information, and
presenting the customer contact plan to the individual so that the individual can utilize the customer contact plan to provide the service to the customer.

10. The system of claim 9 wherein the computer-executable instructions, when executed by the processor, cause the processor to perform the operations further comprising receiving additional customer information form a customer database, the additional information comprising sales information, service information, billing information, installation information, device repair information, customer service chat record information, customer service call record information, customer service email record information, appointment information for an appointment associated with the customer, social network information associated with the customer, or any combination thereof.

11. The system of claim 9, wherein the computer-executable instructions, when executed by the processor, cause the processor to perform the operations further comprising receiving location information associated with the customer, and wherein the computer-executable instructions that, when executed by the processor, cause the processor to perform the operations comprising generating the customer contact plan comprise computer-executable instructions that, when executed by the processor, cause the processor to perform the operations comprising generating the customer contact plan in response to receiving the location information associated with the customer and determining that the location information indicates that the customer is within a predetermined distance of a store associated with the customer access point.

12. The system of claim 9, wherein the computer-executable instructions, when executed by the processor, cause the processor to perform the operations further comprising detecting the customer device associated with the customer and wherein the customer information is received from the customer device at the customer access point in response to the customer access point detecting the customer device and requesting the customer information.

13. The system of claim 9, wherein the computer-executable instructions, when executed by the processor, cause the processor to perform the operations further comprising receiving service completion information that identifies a result of the service provided to the customer in accordance with the customer contact plan.

14. The system of claim 13, wherein the computer-executable instructions, when executed by the processor, cause the processor to perform the operations further comprising updating a customer profile associated with the customer with the service completion information.

15. The system of claim 9, further comprising a display, and wherein the computer-executable instructions, when executed by the processor, cause the processor to perform the operations comprising presenting the customer contact plan to the individual comprise computer-executable instructions that, when executed by the processor, cause the processor to perform the operations comprising presenting the customer contact plan to the individual via the display.

16. A computer storage medium having computer-executable instructions stored thereon that, when executed by a processor, cause the processor to perform operations comprising:
receiving customer information from a customer access point that requests the customer information from a customer device associated with a customer and receives the customer information from the customer device associated with the customer;
generating a customer contact plan based at least in part upon the customer information, the customer contact plan being useable by an individual to provide a service to a customer associated with the customer information; and
presenting the customer contact plan to the individual so that the individual can utilize the customer contact plan to provide the service to the customer.

17. The computer storage medium of claim 16, wherein the computer-executable instructions, when executed by the processor, cause the processor to perform the operations further comprising receiving additional customer information form a customer database, the additional information comprising sales information, service information, billing information, installation information, device repair information, customer service chat record information, customer service call record information, customer service email record information, appointment information for an appointment associated with the customer, social network information associated with the customer, or any combination thereof.

18. The computer storage medium of claim 16, wherein the computer-executable instructions, when executed by the processor, cause the processor to perform the operations further comprising receiving location information associated with the customer, and wherein the computer-executable instructions that, when executed by the processor, cause the processor to perform the operations comprising generating the customer contact plan comprise computer-executable instructions that, when executed by the processor, cause the processor to perform the operations comprising generating the customer contact plan in response to receiving the location information associated with the customer and determining that the location information indicates that the customer is within a predetermined distance of a store associated with the customer access point.

19. The computer storage medium of claim 16, wherein the computer-executable instructions, when executed by the processor, cause the processor to perform the operations further comprising receiving service completion information that identifies a result of the service provided to the customer in accordance with the customer contact plan.

20. The computer storage medium of claim 19, wherein the computer-executable instructions, when executed by the processor, cause the processor to perform the operations further comprising updating a customer profile associated with the service completion information.
